(19) United States
(12) Patent Application Publication
(10) Pub. No.: US 2025/0371995 A1
(43) Pub. Date: Dec. 4, 2025

(54) Metaverse Personalized Digital Singer Generation System and Method Thereof

(71) Applicants: SQ Technology (Shanghai) Corporation, Shanghai (CN); Inventec Corporation, Taipei City (TW)

(72) Inventor: Chuan-Cheng Chiu, Taipei City (TW)

(21) Appl. No.: 18/824,594

(22) Filed: Sep. 4, 2024

(30) Foreign Application Priority Data
May 31, 2024 (CN) 202410705639.3

(51) Int. Cl. G09B 15/00; G06T 17/00; G09B 5/02; G09B 5/06; G10H 1/36; G10L 15/02; G10L 15/06; G10L 21/013; G10L 21/0208

(52) U.S. Cl. CPC G09B 15/00; G06T 17/00; G09B 5/02; G09B 5/065; G10H 1/366; G10L 15/02; G10L 15/063; G10L 21/013; G10L 21/0208; G10H 2210/005

(57) ABSTRACT

A metaverse personalized digital singer generation system and a method thereof. In the system, the server-end device receives a user voice, store the user voice as a personalized voice, capture an image of a user face to generate a facial image, generate a personalized digital singer displayed in a virtual scene through a 3D imaging technology, and convert the personalized voice into voice feature vectors, and use the voice feature vectors and the personalized voice as training data, input the training data to a generative AI model to train a generative pre-training model having the personal characteristics. When the user selects an original song for singing, the original song and the user singing voice and the prompt are inputted to the generative pre-training model, the remixed song matching a style of the original song is outputted, a vocal coaching is generated and displayed based on prompt.

### CROSS-REFERENCE TO RELATED APPLICATION

This application claims the benefit of Chinese Application Serial No. 202410705639.3, filed May 31, 2024, which is hereby incorporated herein by reference in its entirety.

### BACKGROUND OF THE INVENTION

### 1. Field of the Invention

The present invention is related to a generation system and a method thereof, and more particularly to a metaverse personalized digital singer generation system and a method thereof.

### 2. Description of the Related Art

In recent years, with the vigorous development of the Metaverse technologies, various Metaverse applications have sprung up. However, how to improve the usability of the Metaverse has always been an issue that various manufacturers are eager to solve.

Generally, the Metaverse can be realized based on virtual reality, augmented reality, and mixed reality. Currently, some manufacturers have established virtual scene and virtual avatar based on these technologies for users to operate. However, simply operating virtual avatars has gradually been unable to meet the ever-changing needs of users. In view of this, some manufacturers have proposed technical means to change clothes and bodies of virtual avatars to increase the personalization of virtual avatars. However, this manner only simply changes the appearance of the avatar, and does not give the avatar any talents, or combine the avatar with the user's talents. Therefore, the above-mentioned personalization is still insufficient and lacks interest.

According to above-mentioned contents, what is needed is to develop an improved solution to solve the problem of insufficient personalization and interest of a virtual avatar.

### SUMMARY OF THE INVENTION

An objective of the present invention is to disclose a metaverse personalized digital singer generation system and a method thereof, to solve the problem of insufficient personalization and interest of a virtual avatar.

To achieve the objective, the present invention discloses a metaverse personalized digital singer generation system, including a display device, a voice database host, and a server-end device. The display device is configured to display a virtual scene. The voice database host is configured to store personalized voices and a set of voice feature vectors, and original songs. The server-end device is connected to the display device and the voice database host, wherein the server-end device includes a non-transitory computer-readable storage medium and a hardware processor. The non-transitory computer-readable storage medium is configured to store computer readable instructions. The hardware processor is electrically connected to the non-transitory computer-readable storage medium, and configured to execute the computer readable instructions to make the hardware processor execute: continuously receiving a user voice through a voice collection element to store the user voice as a personalized voice, capturing an image of a user face through a camera element to generate a facial image, and generating a personalized digital singer based on the facial image through a 3D imaging technology; performing noise removal and standardization on the personalized voice, and executing an audio processing on the personalized voice to extract features and convert the extracted features as the set of voice feature vectors; continuously inputting the original song, the personalized voice and the set of the voice feature vector to a generative artificial intelligence (AI) model as the training data, to perform training, and form a generative pre-training model after the training; when one of the original songs is loaded and a user singing voice is received through the voice collection element, inputting the loaded original song, the received user singing voice and the at least one prompt to the generative pre-training model, to output a remixed song, wherein the at least one prompt is used to adjust at least one of a volume, a pitch and a timbre of the user singing voice of the remixed song to match the loaded original song based on the set of voice feature vectors; in the virtual scene, displaying the personalized digital singer, broadcasting the remixed song, and generating and displaying a vocal coaching based on the used prompt.

To achieve the objective, the present invention discloses a metaverse personalized digital singer generation method, includes steps of: connecting a display device to a server-end device, and connecting the server-end device to a voice database host, wherein the voice database host stores personalized voices, a set of voice feature vectors, and original songs; continuously receiving a user voice through a voice collection element, storing the user voice as a personalized voice, capturing an image of a user face through a camera element to generate a facial image, generating a personalized digital singer based on the facial image through a 3D imaging technology, and transmitting the personalized digital singer to the display device, by the server-end device; performing noise removal and standardization on the personalized voice, executing an audio processing to extract features, and converting the features into the set of voice feature vectors, by the server-end device; continuously using the original song, the personalized voice and the set of voice feature vectors as training data, inputting the training data to a generative artificial intelligence model for training, and forming a generative pre-training model after the training, by the server-end device; when the server-end device loads one of the original songs and receives a user singing voice through the voice collection element, inputting the loaded original song, the received user singing voice and at least one prompt to the generative pre-training model to output a remixed song, by the server-end device, wherein the at least one prompt is used to adjust at least one of a volume, a pitch and a timbre of the user singing voice in the remixed song to match the original song based on the set of the voice feature vectors; displaying a virtual scene, displaying the personalized digital singer in the virtual scene, playing the remixed song, and generating and displaying a vocal coaching based on the used prompt, by the display device.

According to the above-mentioned system and method of the present invention, the difference between the present invention and the conventional technology is that, in the system, the server-end device receives the user voice, store the user voice as the personalized voice, capture an image of the user face to generate the facial image, generate the personalized digital singer displayed in the virtual scene through the 3D imaging technology, convert the personalized voice into voice feature vectors, use the voice feature vectors and the personalized voice as training data, input the training data to the generative AI model to train the generative pre-training (GPT) model having the personal characteristics. When the user selects an original song for singing, the original song and the user singing voice and the prompt are inputted to the generative pre-training model, the remixed song matching a style of the original song is outputted, and a vocal coaching is generated and displayed based on the prompt.

With the above-mentioned solution, the present invention can improve personalization and enjoyability of virtual avatars.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a metaverse personalized digital singer generation system of the present invention.

FIGS. 2A and 2B are flowchart of a metaverse personalized digital singer generation method of the present invention.

FIG. 3 is a schematic view of a digital singer generation platform operated according to an application of the present invention.

FIG. 4 is a schematic view of a personalized digital singer generated according to an application of the present invention.

FIG. 5 is a schematic view of vocal coaching generated and displayed according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

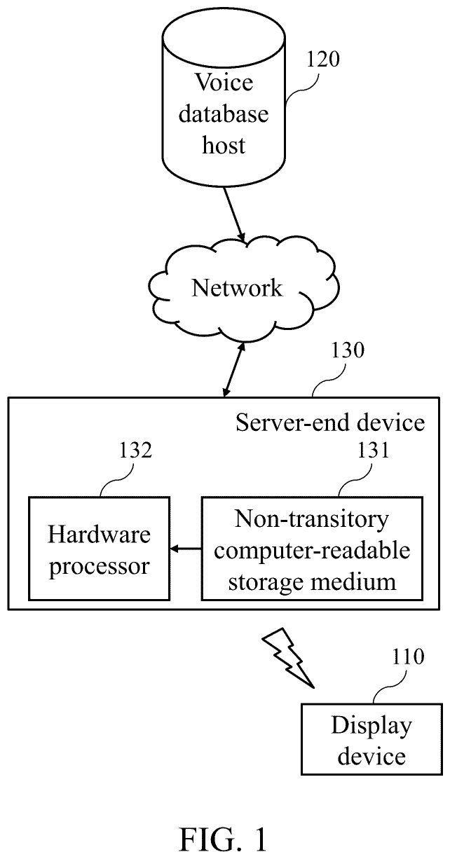

Please refer to FIG. 1. FIG. 1 is a block diagram of a metaverse personalized digital singer generation system of the present invention. The system includes a display device 110, a voice database host 120, and a server-end device 130. The display device 110 is configured to display a virtual scene. In actual implementation, the virtual scene means the scene in the virtual reality, such as a virtual singing stage, virtual singing environment, etc. The personalized digital singer created through 3D modeling is displayed in the virtual scene. In addition, in actual implementation, the display device 110 can be implemented by a head-mounted display device, naked-view 3D display device or the like, but the type of the display device 110 in the present invention is not limited, and any 3D display device can be used in the application field of the present invention.

The voice database host 120 is configured to store one or more personalized voices, a set of voice feature vectors, and original songs. In actual implementation, each of original songs includes audio tracks for recording an original singing voice, a main melody, an accompaniment, and a harmony, respectively, and when the original song selected by a user is loaded, at least one of the audio tracks can be selected to load as training data of the generative AI model. In addition, the personalized voice includes a speech and a singing voice corresponding to a text instruction and a speech instruction, and the text instruction and the speech instruction are displayed and broadcasted in the virtual scene. In other words, the user can be instructed to read an article or sing through the displayed text or broadcasted speech, so as to obtain a personalized voice, so that the voice database host 120 can perform noise removal and standardization on the personalized voice to calculate the voice feature vectors.

The server-end device 130 is connected to the display device 110 and the voice database host 120, the server-end device 130 includes a non-transitory computer-readable storage medium 131 and a hardware processor 132. The non-transitory computer-readable storage medium 131 is used to store computer readable instructions. In actual implementation, the non-transitory computer-readable storage medium 131 may include a hard disk, an optical disk, a flash memory, or the like. The computer readable instructions are executed by the server-end device 130. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages. In actual implementation, the server-end device 130 can be a rack server a tower server, a cloud server, a cluster server, or the like.

The hardware processor 132 is electrically connected to the non-transitory computer-readable storage medium 131 and configured to execute the computer readable instructions, so that the hardware processor 132 can receive the user voice through a voice collection element (such as a microphone), store the user voice as the personalized voice, capture an image of a user face to generate a facial image through a camera element such as charge-coupled device (CCD), CMOS or other image sensor, generate a personalized digital singer based on the facial image through a 3D imaging technology such as stereoscopic visual, multi-angle stereoscopic, light field technology or the like, perform noise removal and standardization on the personalized voice, execute an audio processing to extract features, and convert the features into the set of voice feature vectors. The hardware processor 132 can continuously input the original songs, the personalized voice and the set of the voice feature vectors to a generative AI model as the training data, and form a generative pre-training model after the training. When one of the original songs is loaded, the user singing voice is received through the voice collection element, the loaded original song, the received user singing voice and the prompt are inputted to the generative pre-training model to output a remixed song, the prompt is used to adjust at least one of a volume, a pitch and a timbre of the user singing voice of the remixed song to match the loaded original song based on the set of the voice feature vectors. For example, the pitch of the user singing voice can be adjusted by adjustment to matching standard scale or preset pitch to complete intonation correction. The hardware processor 132 can display the personalized digital singer in the virtual scene, broadcast the remixed song, and generate and display the vocal coaching based on the used prompt. In actual implementation, the prompt can be set with a match degree, such as a threshold or a ratio preset, and the difference between the volume, the pitch and the timbre of the user singing voice and the original song are negatively correlated to the match degree; simply speaking, higher difference indicates lower match degree, and lower difference indicates a higher match degree. In addition, the vocal coaching includes a difference prompt message for difference between the volume, the pitch and the timbre of the original song and the user singing voice, and at least one of a teaching text, an image and a video of the basic vocal technique for reducing the difference. For example, when a difference of pitches of the original song and the user singing voice are higher, the pitch can be automatically adjusted to match the original song through the generative pre-training model, and the difference prompt message including a text “please adjust your pitch” can be generated, and the teaching of a basic vocal technique for adjusting pitch can be embedded in the difference prompt message for user's reference.

It is particularly to be noted that, in actual implementation, the present invention can be implemented fully or partly based on hardware, for example, one or more modules of the system can be implemented by a hardware processor such as integrated circuit chip, system on chip (SOC), a complex programmable logic device (CPLD), or a field programmable gate array (FPGA). The concept of the present invention can be implemented by a system, a method and/or a computer program. The non-transitory computer-readable storage medium 131 records computer readable program instructions, and the processor can execute the computer readable program instructions to implement concepts of the present invention. The computer-readable storage medium can be a tangible apparatus for holding and storing the instructions executable of an instruction executing apparatus. The non-transitory computer-readable storage medium 131 can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium 131 is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub, and/or gateway. The network card or network interface of each calculating/processing apparatus can receive the computer readable program instructions from network and forward the computer readable program instruction to store in the non-transitory computer-readable storage medium 131 of each calculating/processing apparatus.

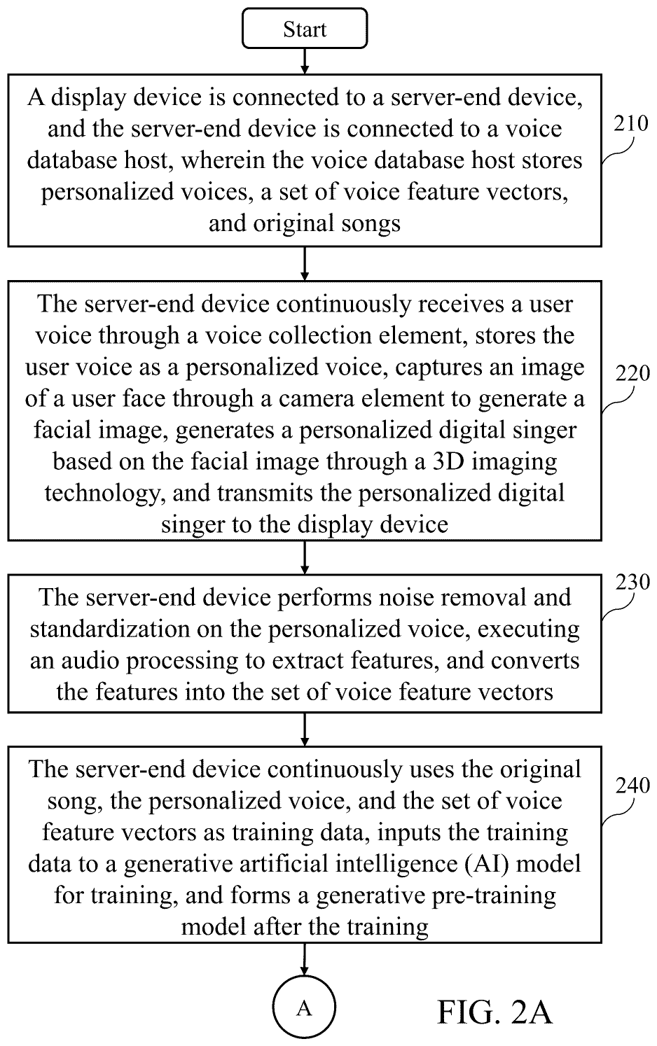

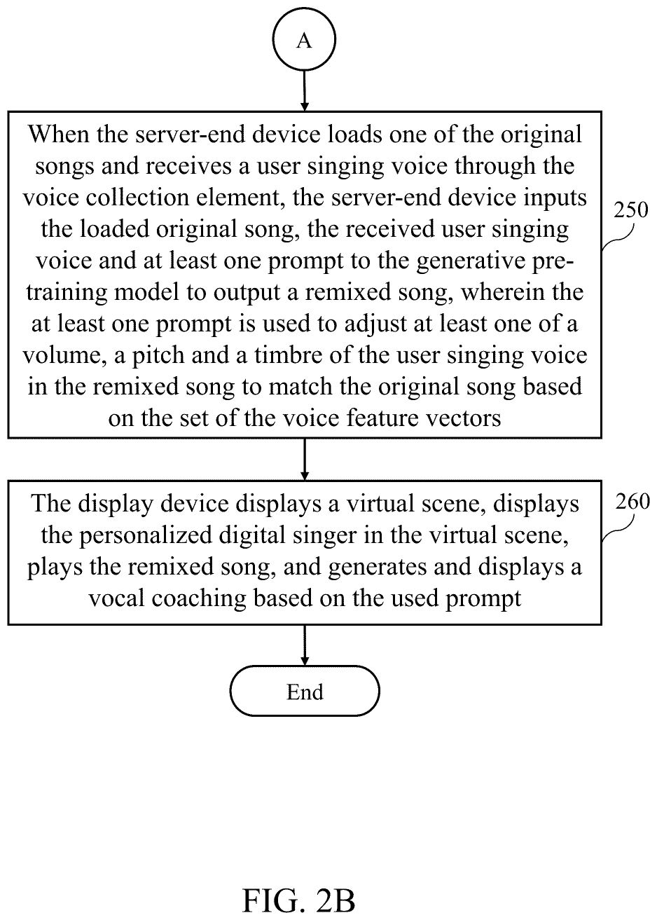

Please refer to FIGS. 2A and 2B. FIGS. 2A and 2B are flowchart of a metaverse personalized digital singer generation method of the present invention. As shown in FIG. 2A and FIG. 2B, the method includes the following steps. In a step 210, a display device 110 is connected to a server-end device 130, and the server-end device 130 is connected to a voice database host 120, wherein the voice database host 120 stores personalized voices, a set of voice feature vectors, and original songs. In a step 220, the server-end device 130 continuously receives a user voice through a voice collection element, stores the user voice as a personalized voice, captures an image of a user face through a camera element to generate a facial image, generates a personalized digital singer based on the facial image through a 3D imaging technology, and transmits the personalized digital singer to the display device 110. In a step 230, the server-end device performs noise removal and standardization on the personalized voice, executing an audio processing to extract features, and converts the features into the set of voice feature vectors. In a step 240, the server-end device 130 continuously uses the original song, the personalized voice, and the set of voice feature vectors as training data, inputs the training data to a generative artificial intelligence model for training, and forms a generative pre-training model after the training. In a step 250, when the server-end device 130 loads one of the original songs and receives a user singing voice through the voice collection element, the server-end device 130 inputs the loaded original song, the received user singing voice and at least one prompt to the generative pre-training model to output a remixed song, wherein the at least one prompt is used to adjust at least one of a volume, a pitch and a timbre of the user singing voice in the remixed song to match the original song based on the set of the voice feature vectors. In a step 260, the display device 110 displays a virtual scene, displays the personalized digital singer in the virtual scene, plays the remixed song, and generates and displays a vocal coaching based on the used prompt. Through aforementioned steps, the server-end device receives the user voice, store the user voice as the personalized voice, capture an image of the user face to generate the facial image, generate the personalized digital singer displayed in the virtual scene through the 3D imaging technology, convert the personalized voice into voice feature vectors, use the voice feature vectors and the personalized voice as training data, input the training data to the generative AI model to train the generative pre-training (GPT) model having the personal characteristics. When the user selects an original song for singing, the original song and the user singing voice and the prompt are inputted to the generative pre-training model, the remixed song matching a style of the original song is outputted, and a vocal coaching is generated and displayed based on the prompt.

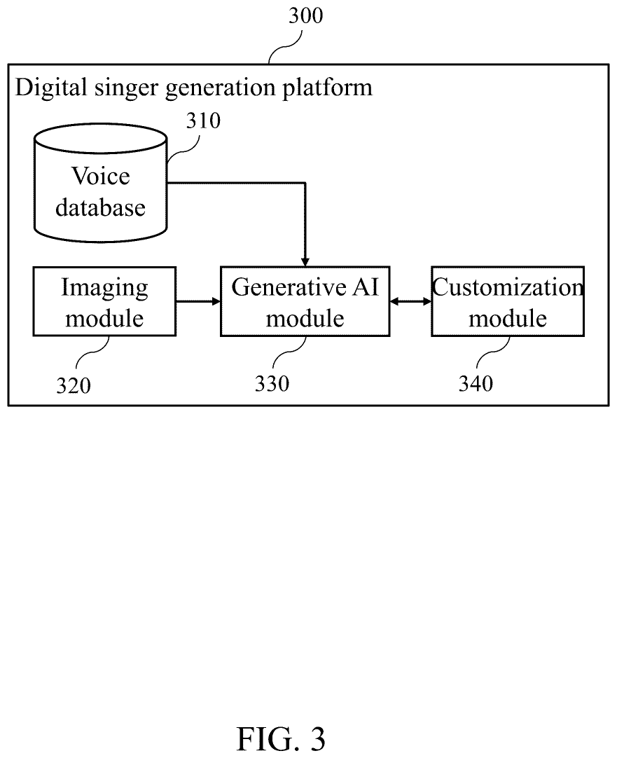

The embodiment of the present invention will be illustrated in the following paragraphs with reference to FIG. 3 to FIG. 5. Please refer to FIG. 3. FIG. 3 is a schematic view of a digital singer generation platform operated according to an application of the present invention. In actual implementation, besides the blocks shown in FIG. 1, the server-end device 130 also can execute a digital singer generation platform 300. The digital singer generation platform 300 includes a voice database 310, an imaging module 320, a generative AI module 330, and a customization module 340. The voice database 310 integrates the database of the voice database host 120 into the server-end device 130. The imaging module 320 uses the camera device to capture an image of the user face to generate the facial image and perform 3D model establishment; The generative AI module 330 is connected to the voice database 310 and the imaging module 320. Compared with the system shown in FIG. 1, the generative AI module 330 can process multimodal data (such as voice and image) at the same time, to output the personalized digital singer; for example, the original song, the personalized voice, the voice feature vectors, and the facial image can be loaded into the generative AI model for training and output the personalized digital singer. The customization module 340 inputs the prompt to the generative AI module 330 to dynamically adjust the singing voice of the personalized digital singer. In other words, the present invention can be implemented by modularization, and the voice database 310 is directly disposed on the server-end device 130.

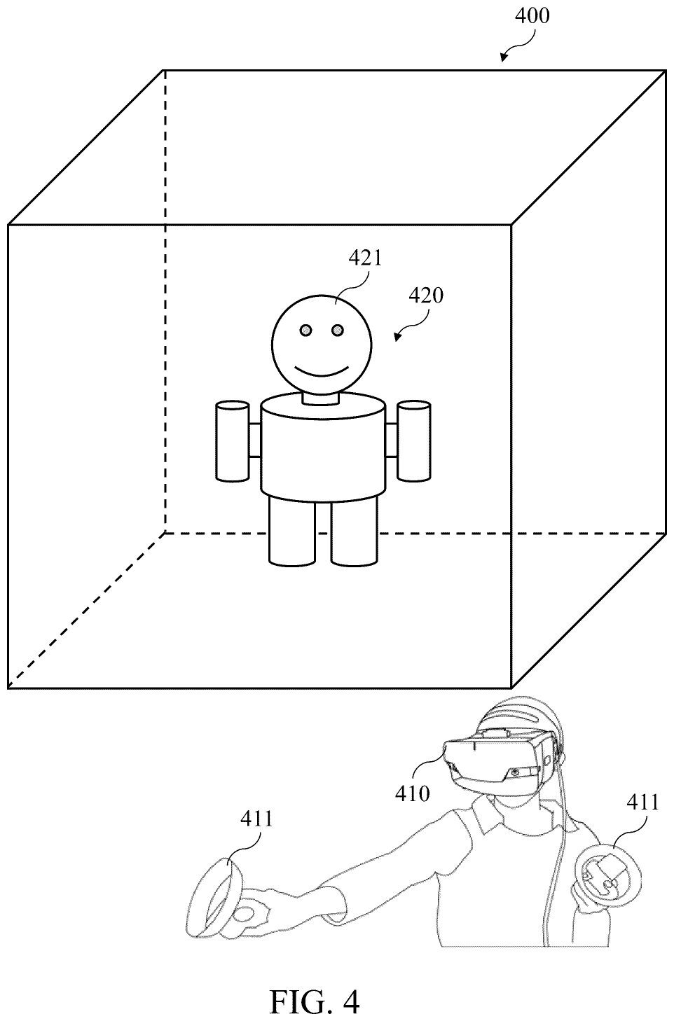

Please refer to FIG. 4. FIG. 4 is a schematic view of a personalized digital singer generated according to an application of the present invention. First, a display device 410 is connected to the server-end device 130, and the server-end device 130 is connected to the voice database host 120. When a user wants to generate a personalized digital singer, the text, speech or a combination thereof are displayed in the virtual scene 400 on the display device 410 to instruct the user to output corresponding speech singing voice singing voice, so that the user voice can be obtained through the voice collection element and stored as the personalized voice. Next, the camera element connected to the server-end device 130 can capture an image of the user face to generate a facial image; in practice, the camera element can capture one or more images of the user face by different angles to generate multiple facial images for establishing 3D model, to form the personalized digital singer. In this way, the personalized voice and the facial image can be used to generate voice and shape of the personalized digital singer.

Next, on the basis of the personalized voice, the server-end device 130 loads the personalized voice stored in the voice database host 120, performs noise removal and a standardization process on the loaded personalized voice, and executes audio processing on the processed personalized voice to extract features and convert the extracted features into a set of voice feature vectors. For example, the noise removal means to remove noise in the personalized voice, and the noise removal can be performed by using a Fourier transform to convert the voice signal into the frequency domain to generate spectrum, reducing the noise in the spectrum based on a noise pattern by a spectrum reduction algorithm or a filter, and then executing an inverse Fourier transform to obtain the personalized voice in which noise is removed. For example, during the standardization process, peak values (that is, the maximal amplitude value of the minimal amplitude value) of the personalized voice are obtained, a gain is calculated to adjust the maximal amplitude of the voice signal to a target value, and the amplitude of the whole voice signal is scaled based on the calculated gain, so as to ensure consistence between the volumes of the voice signal. Through extracting the features and converting the extracted features into the voice feature vectors, the voice feature vectors can be effectively used and processed by the AI model of machine learning. The voice feature vectors also indicate the voice features having the user's personal characteristics.

In addition, on basis of the facial image and through stereoscopic visual 3D reconstruction technology, the feature points and the positions in the 3D space can be calculated based on the facial image with different angles. The feature points are connected to form a 3D grid of the 3D model, and the 3D model is colored based on the original facial image, to complete a head 421 of the personalized digital singer 420. The models of limbs and body of the personalized digital singer 420 can be established by templates, and the established model is transmitted to the display device 410 and displayed in the virtual scene 400. In addition, the personalized digital singer 420 can be adjusted to move based on the preset posture and motion. In practice, the shape of the personalized digital singer 420 can be completed by OpenCV, MeshLab, Unity, Maya or the like.

The server-end device 130 continuously inputs the original song, the personalized voice and the corresponding voice feature vectors to the generative AI model as the training data and forms the generative pre-training (GPT) model after training. When the generative pre-training model is used, the user singing voice, the selected original song and the prompt can be inputted into the generative pre-training model to output a remixed song, the remixed song matches the pitch, the volume and the timbre of the original song and has a voice signal with personal style; simply speaking, the remixed song has the user singing voice adjusted by the generative pre-training model, different from that of the original user singing voice and the original song, and becomes a voice signal with the pitch, volume and timbre similar to that of the original song but also with user unique voice features. The display device 410 displays the personalized digital singer 420 in the virtual scene 400, broadcasts the remixed song, and generates and displays the vocal coaching based on the used prompt. How to generate the vocal coaching will be illustrated in detail with reference to the accompanying drawings. Through the above-mentioned operations, generation of the personalized digital singer 420 is completed, and the personalized digital singer 420 has a shape and voice feature similar to that of the user, so that the operation interest for the user can be effectively improved. In actual implementation, the entire operation process and generated personalized digital singer 420 can be operated by a controller 411.

It is particularly to be noted that the inputted prompt can adjust the remixed song to be outputted, for example, when the prompt is “volume +1”, the gain of the remixed song is increased by 1; when the prompt is “raise a semitone”, the entire remixed song is raised by a semitone, for example, the part with the musical alphabet C corresponding to the pitch Do is raised to musical alphabet C#, the part with the musical alphabet D corresponding to the pitch Re is raised to musical alphabet D #, and so on. In contrast, when the prompt is “flat a semitone”, the entire remixed song is flatted by a semitone, for example, the part with the musical alphabet C is flatted to musical alphabet B corresponding to the pitch Si, and so on. When the prompt is “increase volume of high-frequency area and decrease volume of the low-frequency area”, the high frequency area may be above 4000 Hz, and the low-frequency area may be below 250 Hz, the timbre of the remixed song becomes brighter and clearer.

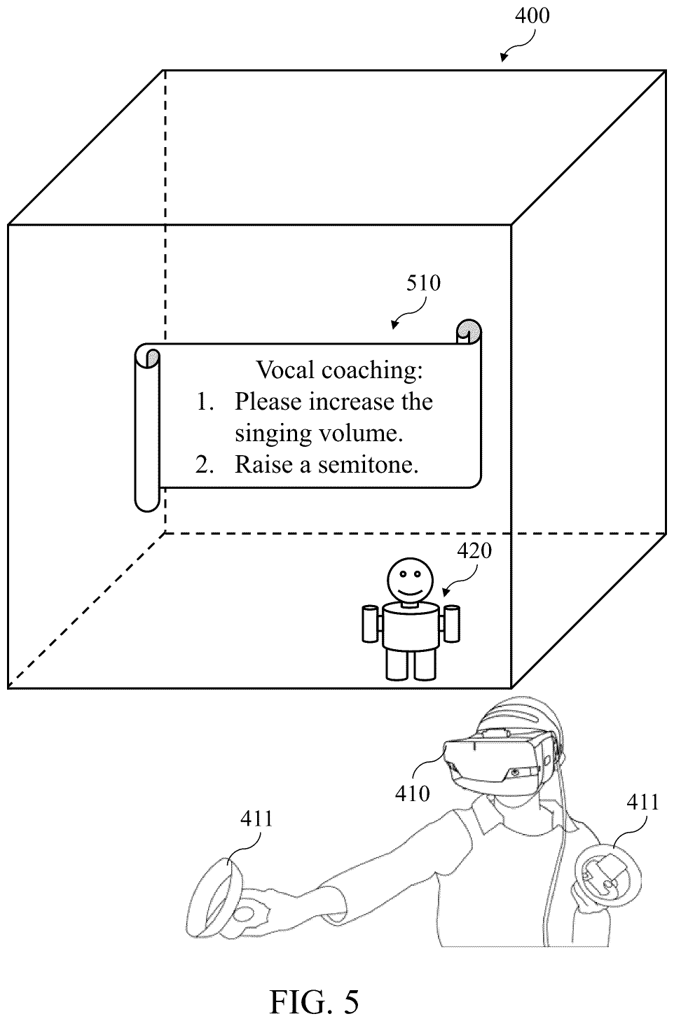

Please refer to FIG. 5. FIG. 5 is a schematic view of the vocal coaching generated and displayed according to an application of the present invention. In an embodiment, when the used prompt is “volume +1”, the generated vocal coaching shows text to guide the user to increase a volume of singing voice; when the used prompt is “raise a semitone”, the generated vocal coaching shows text to guide the user to raise a semitone. For example, the pitch of a part of original song is Do, the user should raise a semitone to sing Do #and do the same way for the other pitches. In other words, the server-end device 130 integrates the adjustment of the inputted prompt as the vocal coaching, so that when the personalized digital singer 420 is displayed in the virtual scene 400, the vocal coaching can be displayed in a display block 510, to guide the user to directly sing with voice similar to the remixed song. In actual implementation, besides displayed text, the guiding operation can be performed by graphics, symbol, video a combination thereof.

According to above-mentioned contents, the difference between the present invention and the conventional technology is that, in the present invention, the server-end device receives the user voice, store the user voice as the personalized voice, capture one or more images of the user face to generate the facial image, generate the personalized digital singer displayed in the virtual scene through the 3D imaging technology, convert the personalized voice into voice feature vectors, use the voice feature vectors and the personalized voice as training data, input the training data to the generative AI model to train the generative pre-training (GPT) model having the personal characteristics. When the user selects an original song for singing, the original song and the user singing voice and the prompt are inputted to the generative pre-training model, the remixed song matching a style of the original song is outputted, and a vocal coaching is generated and displayed based on the prompt. With the above-mentioned solution, the present invention can solve the conventional problem and achieve the effect of improving personalization and enjoyability of virtual avatars.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A metaverse personalized digital singer generation system, comprising:
a display device, configured to display a virtual scene;
a voice database host, configured to store one or more personalized voices and a set of voice feature vectors, and one or more original songs; and
a server-end device, connected to the display device and the voice database host, wherein the server-end device comprises:
a non-transitory computer-readable storage medium, configured to store computer readable instructions; and
a hardware processor, electrically connected to the non-transitory computer-readable storage medium, and configured to execute the computer readable instructions to make the hardware processor execute:
continuously receiving a user voice through a voice collection element to store the user voice as a personalized voice, capturing an image of a user face through a camera element to generate a facial image, and generating a personalized digital singer based on the facial image through a 3D imaging technology;
performing noise removal and standardization on the personalized voice, and executing an audio processing on the personalized voice to extract features and convert the extracted features as the set of voice feature vectors;
continuously inputting the original song, the personalized voice and the set of the voice feature vector to a generative artificial intelligence (AI) model as training data to perform training, and form a generative pre-training model after the training;
when one of the original songs is loaded and a user singing voice is received through the voice collection element, inputting the loaded original song, the received user singing voice and the at least one prompt to the generative pre-training model, to output a remixed song, wherein the at least one prompt is used to adjust at least one of a volume, a pitch and a timbre of the user singing voice of the remixed song to match the loaded original song based on the set of voice feature vectors; and
in the virtual scene, displaying the personalized digital singer, broadcasting the remixed song, and generating and displaying a vocal coaching based on the used prompt.

2. The metaverse personalized digital singer generation system according to claim 1, wherein each of the original songs comprises one or more audio tracks to record an original singing voice, a main melody, an accompaniment, and a harmony, respectively, and when the original song is loaded, at least one of the audio tracks is selected to be loaded as the training data for the generative AI model.

3. The metaverse personalized digital singer generation system according to claim 1, wherein the personalized voice comprises a speech and a singing voice corresponding to one of a text instruction and a speech instruction, and wherein the text instruction and the speech instruction are displayed and broadcasted in the virtual scene.

4. The metaverse personalized digital singer generation system according to claim 1, wherein the prompt is set with a match degree, and wherein the differences between the volumes, the pitches and the timbres of the user singing voice and the original song are negatively correlated to the match degree.

5. The metaverse personalized digital singer generation system according to claim 1, wherein the vocal coaching comprises a difference prompt message for a difference between the volumes, the pitches and the timbres of the original song and the user singing voice, and comprises at least one of a teaching text, an image, and a video of a basic vocal technique for reducing the difference.

6. A metaverse personalized digital singer generation method, comprising,
connecting a display device to a server-end device, and connecting the server-end device to a voice database host, wherein the voice database host stores personalized voices, a set of voice feature vectors, and original songs;
continuously receiving a user voice through a voice collection element, storing the user voice as a personalized voice, capturing an image of a user face through a camera element to generate a facial image, generating a personalized digital singer based on the facial image through a 3D imaging technology, and transmitting the personalized digital singer to the display device, by the server-end device;
performing noise removal and standardization on the personalized voice, executing an audio processing to extract features, and converting the features into the set of voice feature vectors, by the server-end device;
continuously using the original song, the personalized voice and the set of voice feature vectors as training data, inputting the training data to a generative artificial intelligence model for training, and forming a generative pre-training model after the training, by the server-end device;
when the server-end device loads one of the original songs and receives a user singing voice through the voice collection element, inputting the loaded original song, the received user singing voice and at least one prompt to the generative pre-training model to output a remixed song, by the server-end device, wherein the at least one prompt is used to adjust at least one of a volume, a pitch and a timbre of the user singing voice in the remixed song to match the original song based on the set of the voice feature vectors; and
displaying a virtual scene, displaying the personalized digital singer in the virtual scene, playing the remixed song, and generating and displaying a vocal coaching based on the used prompt, by the display device.

7. The metaverse personalized digital singer generation method according to claim 6, wherein each of the original songs comprises one or more audio tracks to record an original singing voice, a main melody, an accompaniment, and a harmony, respectively, and when the original song is loaded, at least one of the audio tracks is selected to be loaded as the training data for the generative AI model.

8. The metaverse personalized digital singer generation method according to claim 6, wherein the personalized voice comprises a speech and a singing voice corresponding to one of a text instruction and a speech instruction, and wherein the text instruction and the speech instruction are displayed and broadcasted in the virtual scene.

9. The metaverse personalized digital singer generation method according to claim 6, wherein the prompt is set with a match degree, the differences between the volumes, the pitches and the timbres of the user singing voice and the original song are negatively correlated to the match degree.

10. The metaverse personalized digital singer generation method according to claim 6, wherein the vocal coaching comprises a difference prompt message for a difference between the volumes, the pitches and the timbres of the original song and the user singing voice, and comprises at least one of a teaching text, an image, and a video of a basic vocal technique for reducing the difference.
